(19) United States
(12) Patent Application Publication
(10) Pub. No.: US 2008/0023683 A1
(43) Pub. Date: Jan. 31, 2008

(54) D-9/D-10 LIFTING MECHANISM

(75) Inventors: David L. Reynolds, Waxahachie, TX (US); Steven R. Smith, San Antonio, TX (US)

Correspondence Address: William B. Nash;Jackson Walker, LLP, Suite 2400, 112 E. Pecan, San Antonio, TX, 78205, US

(73) Assignee: Holt Texas, Ltd.

(21) Appl. No.: 11/495,350

(22) Filed: Jul. 28, 2006

(51) Int. Cl. B66F 7/12

(52) U.S. Cl. 254/89 R

(57) ABSTRACT

A lifting mechanism for track-type vehicles has a rectangular, elongated base skid onto which at least three separately adjustable lifts are positioned. A first lift is positioned at the forward end of the skid and includes a crossbar extending between the elongated sides of the skid. A telescoping, hydraulic jack is positioned at each end of the crossbar, which jacks can be extended to lift the crossbar into engagement with the lower side of a vehicle. Positionable lifting devices are also located along opposing, elongated sides of the skid. Each lifting device is a telescoping hydraulic jack carried at one end of a telescoping arm. The arm is pivotally mounted to the skid at the other end of the arm. The arm's telescopic length and rotational position can be adjusted as necessary to position the lifting device attached thereto as desired under a vehicle.

### BACKGROUND OF THE INVENTION

The present invention relates to the field of heavy duty tracked vehicles. More particularly, the invention relates to a lifting device that can be utilized to lift heavy tracked vehicles to permit the endless tracks of such vehicles to be repaired or replaced.

Treaded or track-type vehicles are well known in the construction and earthmoving industry and typically include an endless track assembly on each side of the vehicle. These endless track assemblies generally include a plurality of interconnected track links, bushings, pins, and track shoes, which are commonly referred to as a track chain. To form the endless track, opposite ends of the track chain are joined together into an endless loop. The track chain is disposed around one or more sprocketed wheels and supporting wheels. The sprocketed wheels are driven by a necessary power source and controls to power the endless track chain and propel the vehicle over varying terrain.

Typically, repair or replacement of any part of the track chain requires that the vehicle be driven forward or backward until the component of the system to be replaced is readily accessible. In most cases, this involves driving the vehicle forward or backward until the operative component is positioned on the upper facing portion of the track between sprocket and supporting wheels. Once this component has been serviced, the vehicle is then driven forward or backward until the next component to be serviced is so positioned. In the case where the entire track is to be replaced, the track may be laid out on the ground and the vehicle is driven down onto the new track.

One drawback to such a system is that the vehicle must be moved in order to properly position a track for servicing. This requires sufficient ground space to maneuver the vehicle until the track component is in the proper position for servicing. In the case of multiple track components that require servicing, it is also time consuming to so move the vehicle in order to properly position the component for servicing. These drawbacks are further complicated to the extent an entire track requires replacement.

### SUMMARY OF THE INVENTION

The present invention provides a lifting mechanism for track-type vehicles that can be utilized to lift such vehicles in place for ease in repair or replacement of the tracks and their components. The system includes a rectangular, elongated base skid onto which at least three separately adjustable lifts are positioned. The skid is dimensioned and shape for placement on the ground so that a tracked vehicle can be driven over and positioned above the skid. A first lift is positioned at the forward end of the skid to be co-extensive with the front or rear end of the vehicle. The first lift includes a cross-bar or supporting beam extending between the elongated sides of the skid and disposed for engaging the lower side of one end of the vehicle. The cross-bar has a telescoping, hydraulic jack positioned at each end, which jacks can be extended to lift the cross-bar into engagement with the lower side of the vehicle. The system further includes positionable lifting devices located along opposing, elongated sides of the skid. Each lifting device is a telescoping hydraulic jack carried at the end of an arm. The arm is pivotally mounted to the skid at the other end of the arm. The arm is capable of telescoping to adjust placement of the arm under the vehicle. The pivotally attached arm can swing out from the skid as necessary to positioning and retracted into a storage position on the skid that facilitates movement of the skid. The positionable lifting devices can be operated in conjunction with one another or independently of one another, as desired.

### BRIEF DESCRIPTION OF THE DRAWINGS

FIG. 1 is an elevation view of the lifting device of the current invention.

FIG. 2 is a side view of the lifting device, with a track-type vehicle depicted thereon.

### DESCRIPTION OF THE PREFERRED EMBODIMENTS

In the detailed description of the invention, like numerals are employed to designate like parts throughout. Various items of equipment, such as fasteners, fittings, etc., may be omitted to simplify the description. However, those skilled in the art will realize that such conventional equipment can be employed as desired.

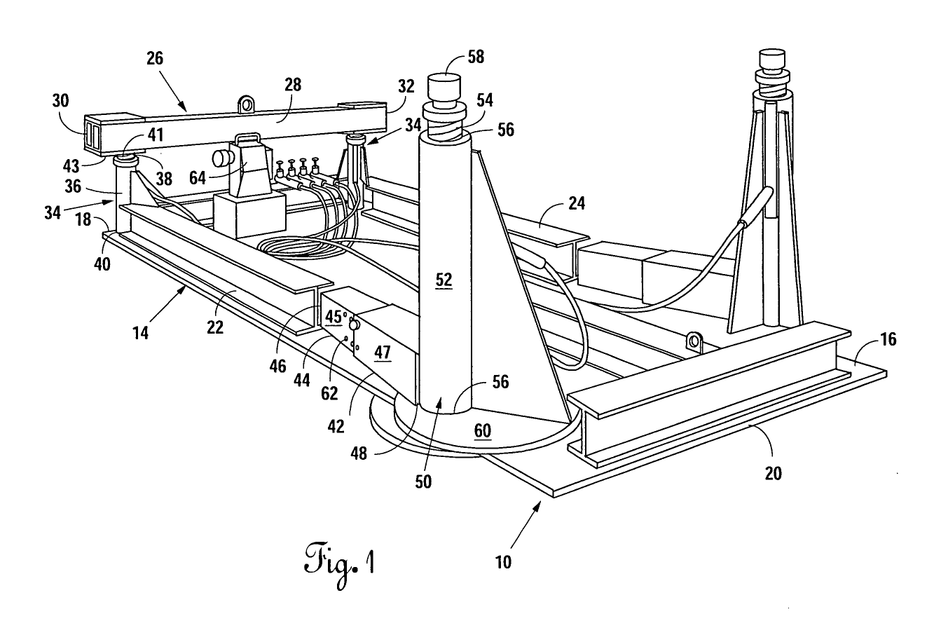

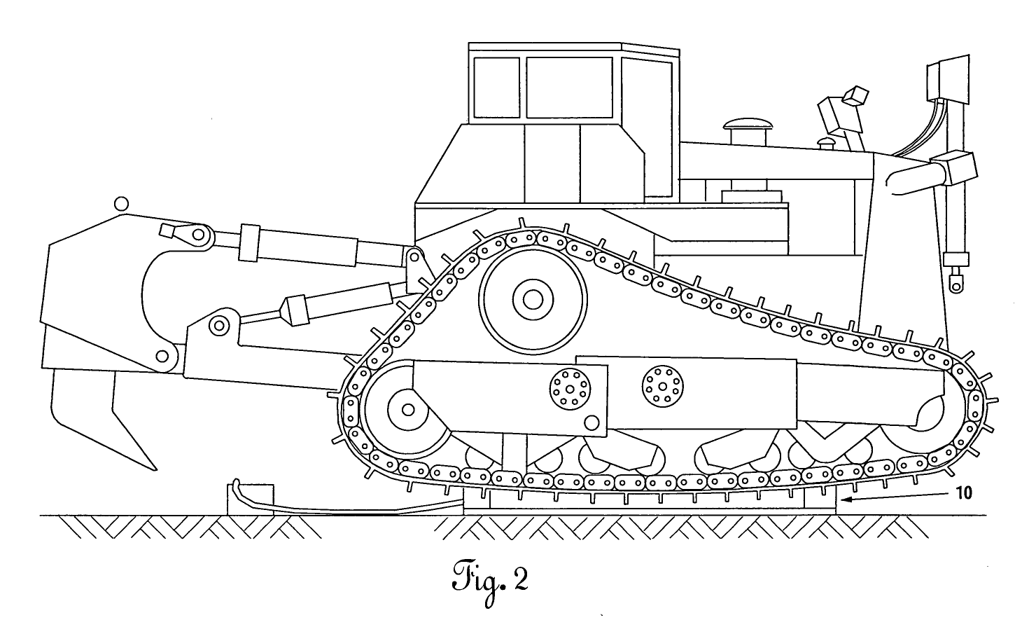

With reference to FIG. 1, there is shown a lift system 10 for lifting track type vehicles, such as vehicle 12 illustrated by dotted lines in FIG. 2. Lift system 10 is generally comprised of a rectangular, elongated skid 14 having a base 16 to which lifting mechanisms are attached. Base 16 generally is characterized as having a first end 18 and a second end 20 and elongated sides 22, 24. Attached adjacent first end 18 is a first lifting device 26. First lifting device 26 has an elongated crossbar 28 that extends between sides 22, 24. Crossbar 28 has a first end 30 and a second end 32. In one embodiment, crossbar 28 is a reinforced, square tube.

Attached at either end of crossbar 28 is a first lift mechanism 34. Alternatively, a single lift mechanism 34 could be attached at approximately the midpoint of crossbar 28. In any event, in the preferred embodiment lift mechanism 34 is comprised of nested, telescoping cylinders 36, 38. A first end 40 of lift mechanism 34 is secured to base 16, while a second end 41 of lift mechanism 34 is secured to a crossbar end 30, 32. In one preferred embodiment, lift mechanism 34 is hydraulically actuated, while in another preferred embodiment, lift mechanism 34 is pneumatically actuated. Under actuation, lift mechanisms 34 extend until crossbar 28 engages the lower side of a vehicle, such as is depicted in FIG. 2. In another embodiment of the invention, crossbar 28 may be eliminated and each lift mechanism 34 can be fitted with an engagement plate 43.

While lift mechanism 34 has been described as nested, telescoping cylinders, those skilled in the art will appreciated that lifting mechanism 34 could be other expandable devices, such as an inflatable bladder (not shown) positioned on base 16 and supporting crossbar 28.

Disposed adjacent each side 22, 24 of base 16 is a second lifting device 42. Each lift second lifting device 42 is comprised of a telescoping arm 44 having a first end 46 and a second end 48 and further characterized by a first portion 45 telescopically nested with a second portion 47. First end 46 of arm 44 is pivotally attached to base 16, preferably along a side 22, 24 thereof. Attached to second end 48 of arm 44 is a lift mechanism 50. While lift mechanism 50 can take many different forms, in one preferred embodiment, lift mechanism 50 is comprised of nested, telescoping cylinders, namely a fixed first cylinder 52 in which a second cylinder 54 is telescopically nested. The lower end 56 of first cylinder 52 is attached to the second end of 48 of arm 44. The upper end 56 of second cylinder 54 may include an engagement head or plate 58 for engaging the lower side of a vehicle. A base plate 60 may be attached to the lower end 56 of first cylinder 52 to provide stability to lift mechanism 50, particularly when lift arm 44 is pivoted out from base 16. In one preferred embodiment, lift mechanism 50 is hydraulically actuated, while in another preferred embodiment, lift mechanism 50 is pneumatically actuated. Likewise, while telescoping arm 44 can be manually expanded or retracted, in one embodiment, arm 44 may include a hydraulic cylinder, pneumatic cylinder or similar actuation device to automatically control operation of arm 44. Arm 44 may also include a fastener 62 to fix first and second portions 45, 47 of arm 44 relative to one another during operation of lift mechanisms 34, 50.

While arm 44 has been described as telescopic, arm 44 can be a fixed length arm. Further, while arm 44 is shown secured to base 16 along a side so that lift mechanism 50 is located at approximately second end 20, arm 44 can be attached anywhere to base 16. In one preferred embodiment, first and second portions 45, 47 of arm 44 are square steel tubing.

Finally, a control mechanism 64 may be provided to control extension and retraction of the various lift mechanisms 34, 50. In one preferred embodiment, control mechanism 64 governs fluid volume, such as a liquid or gas, within the telescoping cylinders. Those skilled in the art will appreciate that control mechanism 64 may be utilized to control lift mechanisms 34, 50 individually or in concert. In this regard, the individual degree of extension of each lift mechanism 34, 50 can be controlled to accommodate the underside profile of a vehicle.

In operation, skid 14 is positioned on a substantially level surface and a track-type vehicle is positioned over skid 14, preferably so that crossbar 28 is below a front or back end of the vehicle. Arms 44 are then pivoted in or out as necessary until each lift mechanism 50 is positioned below a desired contact surface on the lower side of the vehicle. Control mechanism 40 is then operated to cause crossbar 28 and lift mechanisms 50 to telescopically expand to engage the lower side of the vehicle and thereafter, continue to expand until the vehicle is lifted free of the ground or alternatively, the tread to be serviced is lifted free of the ground. Thereafter, the vehicle's tread may be correctly positioned for service without the need for repositioning the vehicle.

While certain features and embodiments of the invention have been described in detail herein, it will be readily understood that the invention encompasses all modifications and enhancements within the scope and spirit of the following claims.

What is claimed is:

1. A lift system for heavy equipment, said lifting system comprising:
a base skid defined by a first end and a second end;
a first lifting device secured to said skid, said first lifting device comprising a crossbar member defined by a first end and a second end and at least one expandable lift mechanism, said lift mechanism having a first portion secured to the base skid and a second portion supporting said crossbar member; and
at least two second lifting devices, each second lifting device pivotally attached to said base skid and comprised of an arm having a first end and a second end and an expandable lift mechanism, wherein said lift mechanism is attached to the second end of said arm and said first end of said arm is pivotally attached to said skid.

2. The lift system of claim 1, wherein each arm of said second lifting device is telescopically expandable.

3. The lift system of claim 1, wherein said first lifting device comprises two expandable lift mechanisms, each attached to an opposite end of the crossbar member.

4. The lift system of claim 3, wherein said two expandable lift mechanisms of said first lifting device are telescoping cylinders.

5. The lift system of claim 4, wherein said telescoping cylinders are hydraulic cylinders.

6. The lift system of claim 4, wherein said telescoping cylinders are pneumatic cylinders.

7. The lift system of claim 1, wherein said expandable lift mechanism of said first lifting device is an expandable bladder.

8. The lift system of claim 4, further comprising a control device for uniformly telescoping said two expandable lift mechanism in synchronization with one another.

9. The lift system of claim 1, wherein each expandable lift mechanism of said second lifting devices is a telescoping cylinder.

10. The lift system of claim 9, wherein said telescoping cylinders are hydraulic cylinders.

11. The lift system of claim 9, wherein said telescoping cylinders are pneumatic cylinders.

12. A lift system for heavy equipment, said lifting system comprising:
a base skid defined by a first end and a second end and opposite sides;
a first lifting device secured to said first end of said skid, said first lifting device comprising a crossbar member defined by a first end and a second end and two telescoping lift cylinders, wherein each lift cylinder has a first fixed end attached to the base skid and a telescoping end attached to an end of said crossbar member; and
at least two second lifting devices, the second lifting device pivotally attached to said base skid adjacent said second end at said opposing sides of said base skid, each of said second lifting devices comprised of an arm having a first end pivotally attached to said base skid and a second telescoping end attached to telescoping lift cylinder; and
a control device for uniformly telescoping said lift cylinders.

13. The system of claim 12, wherein said lift cylinders of said second lifting device further comprised a stability plate attached to said lift cylinders adjacent said arm.
